(19) United States
(12) Patent Application Publication
(10) Pub. No.: US 2025/0008601 A1
(43) Pub. Date: Jan. 2, 2025

(54) SYSTEM AND METHOD FOR L1 CONNECTION SETUP AND L1 RECONFIGURATION

(71) Applicant: Huawei Technologies Co., Ltd., Shenzhen (CN)

(72) Inventors: Hao Tang, Ottawa (CA); Xiaobo Chen, Kanata (CA); Jianglei Ma, Ottawa (CA)

(21) Appl. No.: 18/822,881

(22) Filed: Sep. 3, 2024

Related U.S. Application Data
(63) Continuation of application No. PCT/CN2022/078990, filed on Mar. 3, 2022.

(51) Int. Cl. H04W 76/32; H04W 72/232; H04W 74/0833

(52) U.S. Cl. CPC H04W 76/32; H04W 72/232; H04W 74/0833

(57) ABSTRACT

An L1 setup procedure is provided that can be used in place of RRC setup. The new L1 setup can achieve the same functionality as the current RRC setup, but setup data is exchanged between a BS and UE only in L1. This setup data can include for example, parameters for radio bearer configuration and parameters for master cell group configuration, cell selection configuration, cell reselection configuration, or measurement configuration. A two stage DCI, together with a scheduled physical downlink shared channel (PDSCH) resource may be used for L1 setup, in which the second stage of the two stage DCI indicates that the scheduled PDSCH resource contains L1 data for L1 setup.

### CROSS-REFERENCE TO RELATED APPLICATIONS

This application is a continuation of International Application No. PCT/CN2022/078990, filed on Mar. 3, 2022, which is hereby incorporated by reference in its entirety.

### TECHNICAL FIELD

The application relates to wireless communications generally, and more specifically to connection setup and reconfiguration.

### BACKGROUND

In Long Term Evolution (LTE) and New Radio (NR), a procedure of radio resource control (RRC) connection setup is used to establish an RRC connection. The network applies the procedure, for example when establishing an RRC connection, or when a user equipment (UE) is resuming or re-establishing an RRC connection, and the network is not able to retrieve or verify the UE context. In this case, UE receives RRCSetup and responds with RRCSetupComplete.

Following RRC connection setup, the purpose of RRC reconfiguration is to modify parameters of an existing RRC connection, for example to establish/modify/release resource blocks (RBs), to perform reconfiguration with synchronization, to setup/modify/release measurements, to add/modify/release secondary cells (SCells) and cell groups.

In summary, RRC connection setup is for UE accessing the network. After a UE is connected, RRC reconfiguration is used to establish or modify RRC configuration.

### SUMMARY

An L1 setup procedure is provided that can be used in place of RRC setup. The new L1 setup can achieve the same functionality as the current RRC setup, but setup data is exchanged between a BS and UE only in L1. This can result in time savings an efficiency improvement. This setup data can include for example, parameters for radio bearer configuration and parameters for master cell group configuration, cell selection configuration, cell reselection configuration, or measurement configuration. A two stage DCI, together with a scheduled physical downlink shared channel (PDSCH) resource may be used for L1 setup, in which the second stage of the two stage DCI indicates that the scheduled PDSCH resource contains L1 data for L1 setup.

According to one aspect of the present disclosure, there is provided a method in an apparatus, the method comprising: transmitting a setup request only in layer 1 (L1); receiving a connection setup only in L1, the connection setup comprising parameters for at least one of radio bearer configuration, master cell group configuration, cell selection configuration, cell reselection configuration, or measurement configuration; and transmitting a setup complete only in the PHY layer.

By performing connection setup only in L1, delays and overhead otherwise associated with the use of higher layer signaling, such as RRC, can be reduced.

In some embodiments, receiving a connection setup comprises: receiving a first stage DCI on a physical downlink control channel that schedules a first resource in a physical downlink shared channel; receiving a second stage DCI in the first resource in the physical downlink shared channel that schedules a second resource in a physical downlink shared channel; and receiving L1 data for connection setup in the second resource in the physical downlink shared channel.

The use of two stage DCI allows for flexible resource assignment of the second resource.

In some embodiments, a first set of RACH resources is associated with L1 setup, and a second set of RACH resources is associated with RRC setup; and said RACH resource associated with L1 setup belongs to said first set of RACH resources associated with L1 setup.

Advantageously, with this approach, the network will be aware of whether a setup request is associated with RRC setup, or with L1 setup, simply based on the resource that is used without the need for further signaling.

In some embodiments, the method further comprises receiving signaling indicating the first and second sets of RACH resources.

Advantageously, this allows the sets of RACH resources to be defined through signaling.

In some embodiments, the method further comprises receiving L1 data for reconfiguration only in L1, the L1 data for reconfiguration comprising at least one updated parameter.

By reconfiguration only in L1, delays and overhead otherwise associated with the use of higher layer signaling, such as RRC, can be reduced.

In some embodiments, receiving L1 data for reconfiguration only in L1 comprises: receiving another first stage DCI on the physical downlink control channel that schedules a third resource in the physical downlink shared channel; receiving another second stage DCI in the third resource in the physical downlink shared channel that schedules a fourth resource in the physical downlink shared channel, wherein another second stage DCI indicates that the fourth resource contains L1 data for reconfiguration; and receiving L1 data for reconfiguration in the fourth resource in the physical downlink shared channel.

In some embodiments, the method further comprises transmitting a reconfiguration complete based on the received L1 data for reconfiguration.

Advantageously, upon receipt of the reconfiguration complete, the network will be aware that the reconfiguration is complete.

In some embodiments, the reconfiguration complete includes a parameter that indicates an activation time for the at least one updated parameter.

Advantageously, with this approach, the new parameters can be activated at the same time at the network and the apparatus, and the time is indicated by the apparatus.

In some embodiments, the method further comprises receiving a parameter that indicates an activation time for the at least one updated parameter.

Advantageously, with this approach, the new parameters can be activated at the same time at the network and the apparatus, and the time is indicated by the network.

In some embodiments, receiving L1 data for reconfiguration only in the PHY layer comprises receiving the L1 data segmented across multiple PDSCH transmissions, each indicated by a respective two stage downlink control information (DCI).

L1 data segmentation allows for larger amounts of reconfiguration data to be transmitted.

In some embodiments, the method further comprises receiving signaling to configure whether the apparatus is to use radio resource control (RRC) reconfiguration or L1 configuration.

Advantageously, this gives the network the flexibility in deciding which channel to use for reconfiguration.

In some embodiments, the method further comprises transmitting a physical random access channel (PRACH) transmission on a random access channel (RACH) resource associated with L1 setup; and receiving with a random access response; wherein said transmitting a setup request only in L1 uses resources scheduled in the random access response.

According to another aspect of the present disclosure, there is provided an apparatus comprising: a processor and a memory, the apparatus configured to perform a method as described herein. The advantages described above apply to these embodiments.

According to another aspect of the present disclosure, there is provided a method in a network device, the method comprising: receiving a setup request from an apparatus only in layer 1 (L1); transmitting a connection setup only in L1, the connection setup comprising parameters for at least one of for radio bearer configuration, master cell group configuration, cell selection configuration, cell reselection configuration, or measurement configuration; and receiving a setup complete only in the PHY layer.

The advantageous described above apply to the network device method embodiments.

In some embodiments, transmitting a connection setup comprises: transmitting a first stage DCI on a physical downlink control channel that schedules a first resource in a physical downlink shared channel; transmitting a second stage DCI in the first resource in the physical downlink shared channel that schedules a second resource in a physical downlink shared channel; and transmitting L1 data for connection setup in the second resource in the physical downlink shared channel.

In some embodiments, a first set of RACH resources is associated with L1 setup, and a second set of RACH resources is associated with RRC setup; and said RACH resource associated with L1 setup belongs to said first set of RACH resources associated with L1 setup.

In some embodiments, the method further comprises transmitting signaling indicating the first and second sets of RACH resources.

In some embodiments, the method further comprises transmitting L1 data for reconfiguration only in L1, the L1 data for reconfiguration comprising at least one updated parameter.

In some embodiments, transmitting L1 data for reconfiguration only in L1 comprises: transmitting another first stage DCI on the physical downlink control channel that schedules a third resource in the physical downlink shared channel; transmitting another second stage DCI in the third resource in the physical downlink shared channel that schedules a fourth resource in the physical downlink shared channel, wherein another second stage DCI indicates that the fourth resource contains L1 data for reconfiguration; and transmitting L1 data for reconfiguration in the fourth resource in the physical downlink shared channel.

In some embodiments, the method further comprises receiving a reconfiguration complete based on the transmitted L1 data for reconfiguration.

In some embodiments, the reconfiguration complete includes a parameter that indicates an activation time for the at least one updated parameter.

In some embodiments, the method further comprises transmitting a parameter that indicates an activation time for the at least one updated parameter.

In some embodiments, transmitting L1 data for reconfiguration only in the PHY layer comprises transmitting the L1 data segmented across multiple PDSCH transmissions, each indicated by a respective two stage downlink control information (DCI).

In some embodiments, the method further comprises transmitting signaling to configure whether the apparatus is to use radio resource control (RRC) reconfiguration or L1 configuration.

In some embodiments, the method further comprises receiving a physical random access channel (PRACH) transmission on a random access channel (RACH) resource associated with L1 setup; and transmitting with a random access response; wherein said receiving a setup request only in L1 uses resources scheduled in the random access response.

According to another aspect of the present disclosure, there is provided a network device comprising: a processor and memory, the network device configured to perform a method as described herein.

The advantageous described above apply to the network device embodiments.

According to another aspect of the present disclosure, there is provided a non-transitory computer-readable medium having stored thereon, computer-executable instructions, that when executed by a computer, cause the computer to perform one of the methods as described herein.

### BRIEF DESCRIPTION OF THE DRAWINGS

Embodiments of the disclosure will now be described with reference to the attached drawings in which:

FIG. 1 is a block diagram of a communication system;

FIG. 2 is a block diagram of a communication system;

FIG. 3 is a block diagram of a communication system showing a basic component structure of an electronic device (ED) and a base station;

FIG. 4 is a block diagram of modules that may be used to implement or perform one or more of the steps of embodiments of the application;

FIG. 5A shows an example of a protocol stack including L1 and RRC layers among others;

FIG. 5B is a signal flow diagram for RRC connection establishment;

FIG. 6 is a signal flow diagram for RRC reconfiguration;

FIG. 7 shows distinct resource assignment for RRC setup and L1 setup;

FIG. 8 is a signal flow diagram for an L1 setup procedure;

FIG. 9 shows time frequency resources for a two stage DCI;

FIG. 10 is a signal flow diagram for an L1 reconfiguration;

FIG. 11 depicts an example of delayed activation of updated parameters; and

FIG. 12 shows an example of L1 segmentation.

### DETAILED DESCRIPTION OF ILLUSTRATIVE EMBODIMENTS

The operation of the current example embodiments and the structure thereof are discussed in detail below. It should be appreciated, however, that the present disclosure provides many applicable inventive concepts that can be embodied in any of a wide variety of specific contexts. The specific embodiments discussed are merely illustrative of specific structures of the disclosure and ways to operate the disclosure, and do not limit the scope of the present disclosure.

In future networks, such as 6G, it is expected more UE requirements and more UE capabilities will be introduced, for example, an extreme power saving requirement, and UEs with and without artificial intelligence (AI). As a consequence, if the same design principle of 5G NR is followed for DCI, there will be a significant number of DCI formats/sizes in 6G, which will lead to a significant burden on the UEs in performing blind decoding. The introduction of new DCI formats is complicated by DCI size alignments and may not be forward compatible. In addition, the number of blind decodings for the UE to perform is increased with the number of active carriers. Therefore, it would be advantageous to be able to reduce the number of blind decodings that the UEs need to perform.

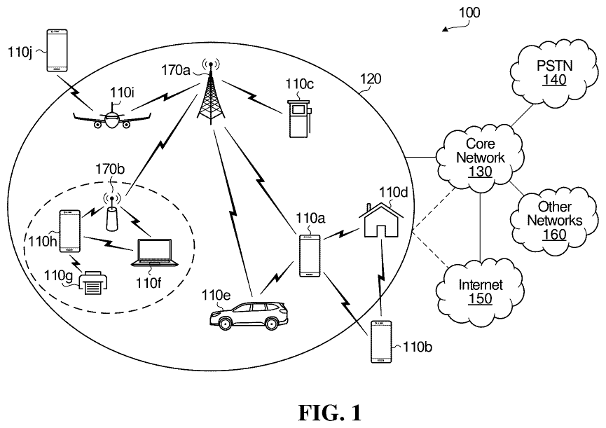

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

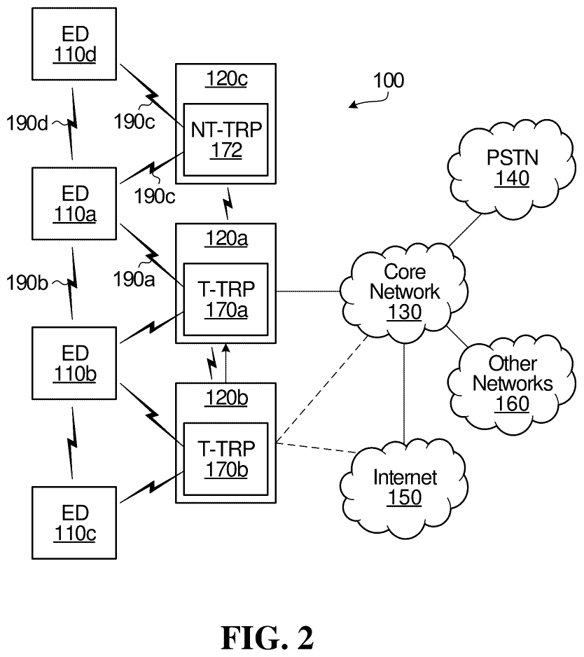

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 16o, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

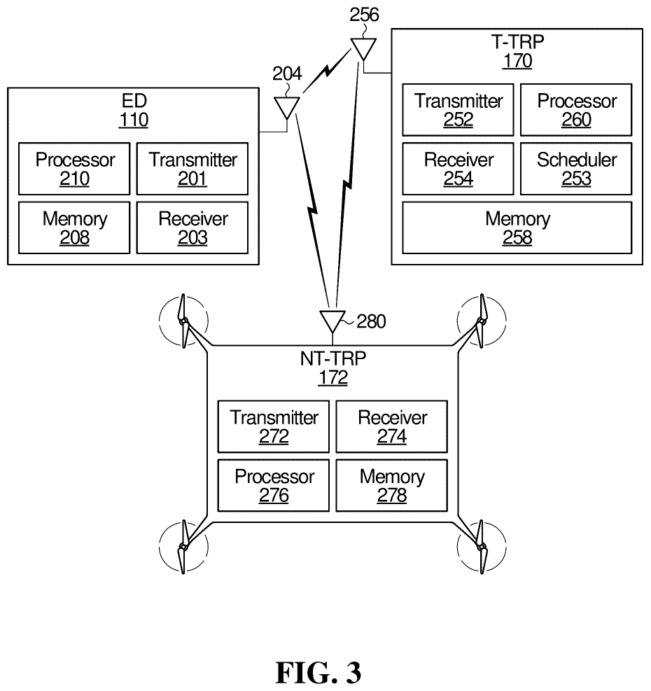

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

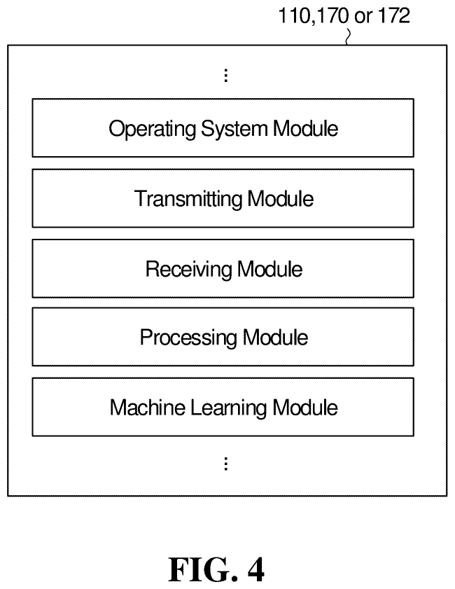

One or more steps of the embodiment methods provided herein may be performed by corresponding units or modules, according to FIG. 4. FIG. 4 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

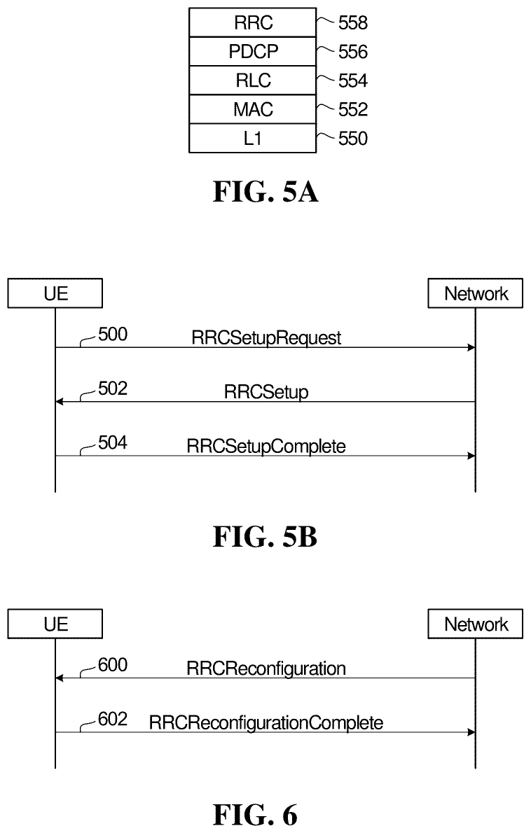

An example of a protocol stack is shown in FIG. 5A. The stack has layer 1 (L1) 550, also often referred to as the physical layer or PHY, medium access (MAC) layer 552, radio link control (RLC) 554, packet data convergence control (PDCP) 556, and RRC 558.

An example of an RRC connection setup procedure is shown in FIG. 5B. This involves transmission from a UE to a network of an “RRCSetupRequest” at 500. The network responds at 502 with “RRCSetup”. Then at 504 the UE sends “RRCSetupComplete”. These are sent at the RRC layer.

An example of an RRC connection reconfiguration procedure is shown in FIG. 6. This involves transmission from the network to a UE of “RRCReconfiguration” at 600. The UE responds at 602 with “RRCReconfigurationComplete”. These are sent at the RRC layer.

Problems with the RRC setup and reconfiguration procedures of FIGS. 5B and 6 include:
significant header overhead: transmission of signaling at the RRC layer, which is a higher layer, involve the addition and transmission of headers for RRC, but also headers for each layer below the RRC layer, PDCP, RLC, MAC layers;
large processing delay: there is a processing delay in each layer, causing large initial access delay and also causing an RRC ambiguity issue. When a base station (BS) reconfigures some RRC parameters, the activation time of the new parameters is unknown between the BS and UE, and the BS and UE may not align the activation time of the new RRC parameters; during this period, there is RRC ambiguity. During the period of RRC ambiguity, a base station may use default RRC parameters.

### Layer 1 (L1) Setup

In accordance with an embodiment of the disclosure, an L1 setup procedure is provided that can be used in place of RRC setup. The new L1 setup can achieve the same functionality as the current RRC setup, but setup data is exchanged between a BS and UE only in the physical layer (PHY). The expression L1 setup means establishing a connection between BS and UE only in L1 transmission. This can include for example, at least one of parameters for radio bearer configuration and parameters for master cell group configuration, cell selection configuration, cell reselection configuration, or measurement configuration.

In some embodiments, a two stage DCI, together with a scheduled physical downlink shared channel (PDSCH) resource is used for L1 setup, in which the second stage of the two stage DCI indicates that the scheduled PDSCH resource contains L1 data for L1 setup. Further details of the two stage DCI are provided below.

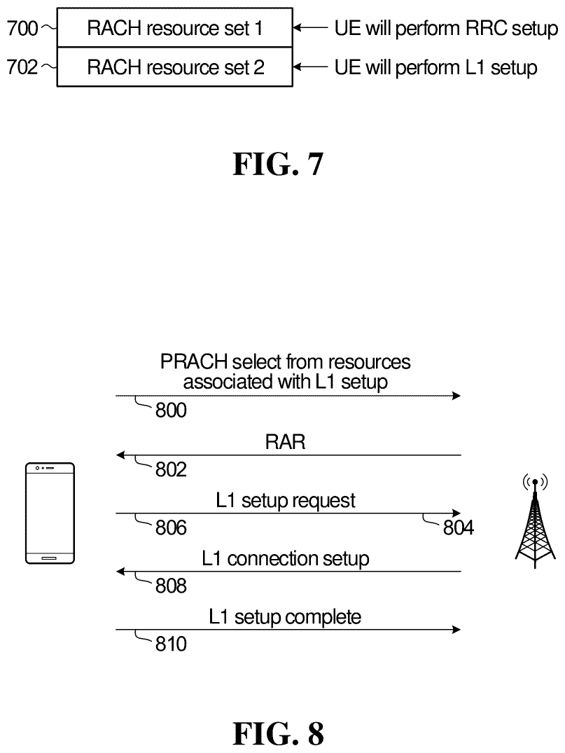

In some embodiments, multiple sets of random access channel (RACH) resources are available for connection setup. One set of RACH resources is associated with RRC setup and another set of RACH resources is associated with L1 setup. An example is shown in FIG. 7. RACH resource set 1 700 is for RRC setup, and RACH resource set 2 is for L1 setup. A BS may indicate the multiple sets of RACH resources to a UE. For example, a BS may indicate the sets of RACH resources in a transmitted system information block (SIB). When a UE supports L1 setup, it will use the set of RACH resources which is associated with the L1 setup. On the other hand, a UE that does not support L1 setup, and will need to rely on RRC setup using RRC messaging, will use the set of RACH resources which is associated with RRC setup.

For L1 setup, a UE sends a physical random access channel (PRACH) signal using the RACH resource. Upon receiving the PRACH signal, the BS knows whether the UE will perform L1 setup or RRC setup. For L1 setup, the setup request, connection setup, setup complete are L1 data, which is exchanged only between physical layer of BS and UE.

A detailed example of an L1 setup procedure provided by an embodiment of the disclosure is shown in FIG. 8, where all messaging takes place only in the PHY layer. At 800, to initiate L1 setup, a UE sends a PRACH signal using the RACH resource associated with L1 setup. Upon receipt of the PRACH signal, a BS will know that the UE is performing L1 setup. At 802, the BS responds with a random access response (RAR). The RAR may indicate, for example, one or more of, in some embodiments all of: which PRACH preamble the RAR is related to, a timing advance value, a scheduling grant for sending a transmission using PUSCH (namely L1 setup request introduced further below), and a temporary Cell Radio Network Temporary Identifier (TC-RNTI). At 804, the UE sends “L1 setup request” to BS using PUSCH scheduled by RAR, which is an uplink L1 data. The L1 setup request is used to request the establishment of a connection by L1 signal. The L1 setup request includes the UE identity. At 808, the BS sends “L1 connection setup” to the UE. L1 connection setup may, for example, be used to establish a radio bearer, for example a signaling radio bearer, such as signaling radio bearer 1 (SRB1). The L1 connection setup may for example, include parameters for one or both of radio bearer configuration and master cell group configuration. At 810, the UE sends “L1 setup complete” to BS. L1 setup complete is used to confirm the successful completion of a L1 connection establishment procedure. It can be seen that there is no RRC/PDCP/RLC/MAC header overhead involved in the provided L1 setup procedure.

In some embodiments, a two-stage DCI structure is used to transmit data for L1 setup (or L1 reconfiguration, detailed below) from the BS to the UE.

The DCI includes two parts, i.e. first stage DCI and corresponding second stage DCI. The UE may receive the first stage DCI and the second stage DCI in the L1 connection setup from the BS, for example. The first stage DCI and the second stage DCI are transmitted in different physical channels, e.g. the first stage DCI is carried on a PDCCH and the second stage DCI is carried on a PDSCH, wherein the second stage DCI is not multiplexed with UE DL data, i.e. the second stage DCI is transmitted on a PDSCH without DL-SCH. The first stage DCI indicates control information for the second stage DCI, including time/frequency/spatial resources of the second stage DCI. Optionally, the first stage DCI can indicate the presence of the second stage DCI. If the second stage DCI is present, a UE needs to receive both the first stage and the second stage DCI to get the control information for data for L1 setup or reconfiguration. For the contents of the first stage DCI and second stage DCI, the first stage DCI includes the control information for the second stage DCI and the second stage DCI includes the control information for the data for L1 setup or reconfiguration; or the first stage DCI includes the control information for the second stage DCI and partial control information for the data for L1 setup or reconfiguration, and the second stage DCI includes partial or whole control information for the data for L1 setup or reconfiguration. If the second stage DCI is not present, which may be indicated by the first stage DCI, a UE receives the first stage DCI to get the control information for data for L1 setup or reconfiguration.

As noted above, the physical resources of the PDSCH used to transmit the second stage DCI are used for a transmission including the second stage DCI without multiplexing with other downlink data. For example, where the unit of transmission on the PDSCH is a physical resource block (PRB) in frequency-domain and a slot in time-domain, an entire resource block in a slot is available for second stage DCI transmission. This allows maximum flexibility in terms of the size of the second stage DCI, without the constraints on the amount of DCI that could be transmitted that would be introduced if multiplexing with downlink data was employed. This also avoids the complexity of rate matching for downlink data if the downlink data is multiplexed with DCI.

The UE receives the first stage DCI (for example by receiving a physical channel carrying the first stage DCI) and performs decoding (e.g. blind decoding) to decode the first stage DCI. Scheduling information for the second stage DCI, within the PDSCH, is explicitly indicated by the first stage DCI. The result is that the second stage DCI can be received and decoded by the UE without the need to perform blind decoding, based on the scheduling information in the first stage DCI.

Because the second stage DCI is not limited by constraints that may exist for PDCCH transmissions, the size of the second stage DCI is very flexible, and may be used to indicate scheduling information for one carrier, multiple carriers, multi-transmissions for one carrier.

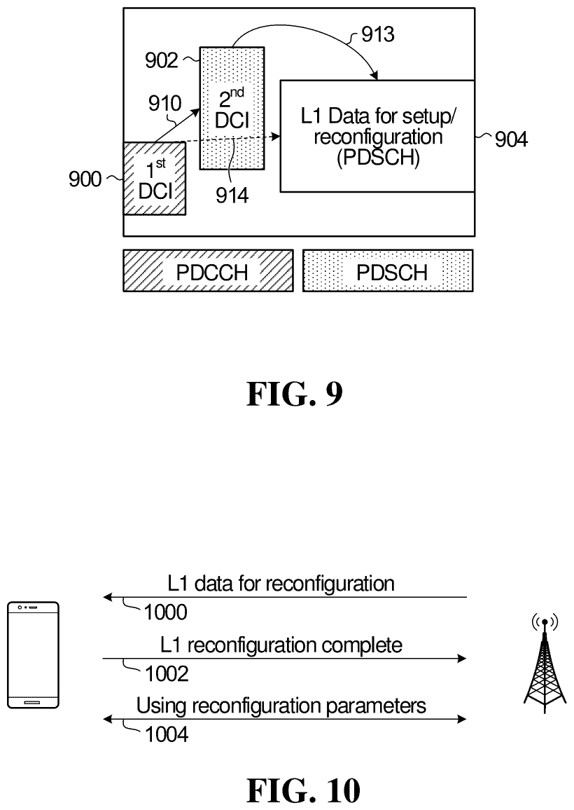

An example of the resources that might be used for the two stage DCI is shown in FIG. 9. In FIG. 9, time (orthogonal frequency division multiplexing (OFDM) symbol durations) is in the horizontal axis, and frequency (OFDM subcarriers) is in the vertical direction. Shown is a first stage DCI 900 transmitted using a PDCCH, where a PDCCH includes one or more control channel elements (CCEs), and a second stage DCI 902 transmitted on a PDSCH using one or more PRBs and one or more symbols. The first stage DCI 900 includes a scheduling information of the second stage DCI 902, depicted graphically by arrow 910. Also shown is data for L1 setup or reconfiguration which occupies PDSCH resources 904 scheduled by the second stage DCI.

In some embodiments, scheduling information of the second stage DCI indicates parameters of at least one of a time domain resource, a frequency domain resource and a spatial domain resource of the second stage DCI. The first stage DCI may also indicate at least modulation order of the second stage DCI, coding rate of the second stage DCI, partial or full scheduling information for a data channel transmission.

The second stage DCI includes scheduling information for PDSCH resources for the L1 data for setup or reconfiguration. Referring to FIG. 9, for this case, arrow 910 represents the indication of the time and/or frequency and/or spatial resources and/or modulation order and/or coding rate of the second stage DCI, and arrow 913 represents the scheduling information for data, e.g. PDSCH for data for L1 setup or reconfiguration.

In some embodiments, the first stage DCI indicates scheduling information of the second stage DCI, and also includes partial scheduling information for a data transmission of data for L1 setup or reconfiguration, such as one or more of time/frequency/spatial resource allocation, modulation order, coding rate, HARQ information, UE feedback resources, or power control for data. The second stage DCI includes additional detailed scheduling information for data, e.g. the information not indicated by first stage DCI, or an update to the information indicated by first stage DCI for data. Thus, for example, the second stage DCI may schedule a resource in the PDSCH (e.g. a resource over which L1 connection setup is transmitted by the BS) and the UE may receive, from the BS, L1 data for connection setup in the scheduled resource. Referring to FIG. 9, for this case, arrow 910 represents the indication of the time and/or frequency and/or spatial resources and/or modulation order and/or coding rate of the second stage DCI. Arrow 914 represents partial scheduling information for data transmission of data for L1 setup or reconfiguration. Arrow 913 represents the detailed scheduling information for data for L1 setup or reconfiguration.

The first stage DCI is blind decoded by the UE. Because the scheduling information of the second stage DCI is indicated by the first stage DCI, no blind decoding is required for the second stage DCI.

### L1 Reconfiguration

In accordance with an embodiment of the disclosure, an L1 reconfiguration procedure is provided that can be used in place of RRC reconfiguration. L1 reconfiguration involves modifying a connection between a BS and UE only by L1, e.g. establish/modify/release Radio Bearers, setup/modify/release measurements, add/modify/release cell configuration, cell group configurations, network parameter configuration.

The new L1 reconfiguration can achieve the same functionality as current RRC reconfiguration, but reconfiguration data is exchanged between a BS and UE only in the physical layer (PHY).

In some embodiments, a two stage DCI, together with a scheduled physical downlink shared channel (PDSCH) resource is used for L1 reconfiguration, in which the second stage of the two stage DCI indicates that the scheduled PDSCH resource contains L1 data for L1 reconfiguration.

An L1 reconfiguration procedure is provided to replace some functionalities of RRC reconfiguration, including modify parameters that would normally be configured or reconfigured by RRC signaling. An example is shown in FIG. 10 which shows the transmission of L1 data for reconfiguration from the BS to the UE at 1000. Also, shown is the optional step of the UE transmitting L1 reconfiguration complete at 1002, described in further detail. After updating the parameters, communication proceeds using the updated parameters at 1004.

In some embodiments, the above-described two stage DCI is used. To inform UE that there is scheduled PDSCH for L1 reconfiguration, a field in the 2nd stage DCI indicates it is L1 reconfiguration. For example, in some embodiments, there is a field called “L1 reconfiguration indicator” in the 2^{nd} stage DCI, the size is 1 bit, value 1 means that the scheduled PDSCH is for L1 reconfiguration in PHY.

In some embodiments, the parameters subject to update are divided into sets. A specific example of how the parameters may be divided into sets follows below:
Set 1: {masterCellGroup, secondaryCellGroup, mrdc-SecondaryCellGroupConfig},
Set 2: {radioBearerConfig, measConfig}
Set 3: {BWP-DownlinkDedicated, BWP-UplinkDedicated}
Set 4: {AI-training, AI-implementation, AI-update}
Set 5: {waveform type, DMRS configuration, SRS configuration, codeword number}

In some embodiments, these sets are preconfigured. In some embodiments, they are configured by signaling transmitted from the BS to the UE. Each set of parameters has an associated index for identification purposes.

For this embodiment, the 2^{nd} stage DCI indicates the following:

“Parameter set indicator”: an indication of the index of one of the sets of parameters; and

“Parameter presence indicator”: N bits bitmap, where N is the number of parameters in the indicated set. There is a respective bit in the bitmap for each parameter in the indicated set. A first value (e.g. value 1) means the parameter is included in the L1 reconfiguration data scheduled by the 2^{nd} stage DCI. A second value (e.g. value 0) means the parameter is not included in the L1 reconfiguration data scheduled by the 2^{nd} stage DCI.

The PDSCH resources scheduled by the DCI then contain values for the parameters indicated to be included. Based on “Parameter set indicator” and “Parameter presence indicator”, a UE knows which parameter(s) are being updated by L1 reconfiguration, and derives the update value from the L1 reconfiguration data which is scheduled by the 2^{nd} stage DCI.

In some embodiments, for a UE supporting both RRC reconfiguration and L1 reconfiguration, the BS could configure whether the UE is to use RRC reconfiguration or L1 reconfiguration. This may be performed by physical layer signaling (DCI) or high layer signaling (MAC-CE, RRC signaling). In the case of DCI, if the indicated reconfiguration method is different from UE's current reconfiguration method, the UE switches to the indicated reconfiguration method after a certain time slot, where length of the time slot is predefined, preconfigured or indicated. This avoids ambiguity between the UE and the BS as to which method is being used.

### UL L1 Reconfiguration Complete

In some embodiments, following the transmission of L1 reconfiguration signal, the UE transmits another UL L1 signal to confirm successful completion of reconfiguration. An example is shown in FIG. 10. After the UE receives the L1 data for reconfiguration, and activates use of the parameters indicated therein, the UE transmits a “L1 Reconfiguration Complete” at 1002 indicating that L1 reconfiguration is complete.

In some embodiments, in order to allow an association between the L1 reconfiguration complete and a previous transmission of L1 data for reconfiguration, in the DCI scheduling L1 data for reconfiguration, the BS indicates a “L1 reconfiguration identifier” to the UE, that functions as an identifier of the reconfiguration process. After receiving L1 data for reconfiguration, the UE transmits the “L1 Reconfiguration Complete”, and includes the L1 reconfiguration identifier and ACK/NACK status for the L1 reconfiguration with the indicated reconfiguration identifier. In some embodiments, “L1 Reconfiguration Complete” is sent together with HARQ-ACK for the PDSCH carrying the L1 data.

To avoid ambiguity (analogous to the above discussed RRC ambiguity, but pertaining to signaling in the L1 layer) regarding when the connection reconfiguration takes effect (for example, due to time taken to implement parameter changes at the UE and/or the BS), in some embodiments, for parameter reconfiguration in PHY using the described L1 reconfiguration, the BS indicates to the UE an activation time for the updated parameters. Alternatively, the UE reports the activation time of the updated parameters.

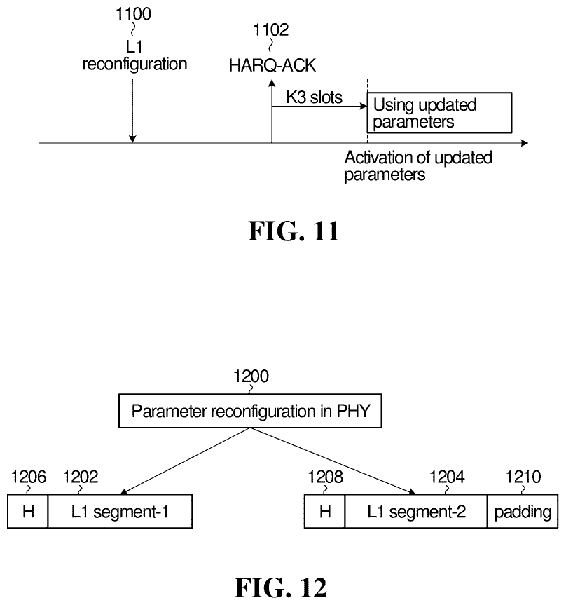

For example, the BS may indicate the activation time of updated parameters relative to a reference time. For example, the BS may indicate the activation time in units of slots following a HARQ-ACK slot. An example is shown in FIG. 11 which shows the L1 reconfiguration 1100. The L1 reconfiguration 1100 indicates a value K3, which is a number of slots following a reference slot after which the updated parameters become activated at 1104. In this example, K3 is defined relative to HARQ-ACK transmission.

In another embodiment, the UE reports the activation time as part of the above described “L1 Reconfiguration Complete”.

These embodiments facilitate fast parameter modification by L1 reconfiguration compared to the use of RRC reconfiguration.

### L1 Segmentation

For some L1 data whose payload size is large, e.g. AI/ML related parameters or data (e.g. intermediate data during AI training/update), one transmission may be insufficient to carry such a large payload. A method of segmentation in the PHY layer is provided. This will be described by way of example with reference to FIG. 12. In FIG. 12, shown at 1200 is a set of parameters for parameter reconfiguration via L1 reconfiguration. The amount of reconfiguration data is too large to be included in a single L1 transmission.

In order to transmit the data using L1 transmission, the reconfiguration data is divided into segments each having a size suitable for L1 transmission. In FIG. 12, shown are two segments 1202,1204. For the last segment, padding bits may be required if the size of the segment is not aligned with payload size that is carried by the physical channels. For example, in FIG. 12, padding bits 1210 are applied to segment 1204. While described for the transmission of reconfiguration data using L1, more generally, the described segmentation technique can be used for the transmission of any type of downlink information using L1. For example, this segmentation technique may be used to transmit data for L1 setup.

For each segment, there is a header to indicate information for the segment. In the example of FIG. 12, shown are headers 1206,1208. The header may be included in a 2nd stage DCI, or may be included in the scheduled PDSCH. In a specific example, the header includes one or more of the following fields:
L1 Sequence Number (SN): SN field indicates the sequence number of DCI segment; the sequence number is incremented by one for each segment;
Segmentation Information (SI): SI field indicates whether a DCI contains a complete DL information or the first, middle, last segment of a DL information;
Segment Offset (SO): SO field indicates the position of the L1 segment within the original L1 transmission
Segment Numbers (SNs): SNs field indicates the total number of the segments for the L1 transmission

Based on the header information, a UE can obtain information on the segmentation of the downlink information. After receiving all the segments successfully, UE sends an ACK to BS to confirm successful reception all of the segments.

This approach can be used to support the transmission of large amounts of data using L1.

As described above, the new L1 procedures allow for L1 connection setup, and for L1 reconfiguration without the use of RRC or other higher layer protocols. In some embodiments, internal messaging between the L1 layer and RRC layer are implemented to inform the RRC layer of the results of the procedures executed at the L1 layer. Other RRC functions may continue to be executed using the RRC layer, including the exchange of RRC messaging at the RRC layer for functions other than setup and reconfiguration.

Alternatively, in some embodiments, RRC messaging at the RRC layer is dispensed with completely; all messaging that would have been performed at the RRC layer is performed at the L1 layer, for example using the described two stage DCI. There may still be RRC layer functionality for processing the parameters included in the L1 transmission. For example, the major functions of the RRC protocol typically include connection establishment and release functions, broadcast of system information, radio bearer establishment, reconfiguration and release, RRC connection mobility procedures, paging notification and release and outer loop power control. In this embodiment, by means of the L1 signaling in place of RRC signaling, the RRC signaling is used to configure the user and control planes according to the network status and allows for Radio Resource Management strategies to be implemented.

Numerous modifications and variations of the present disclosure are possible in light of the above teachings. It is therefore to be understood that within the scope of the appended claims, the disclosure may be practiced otherwise than as specifically described herein.

What is claimed is:

1. A method, comprising:
transmitting a setup request only in layer 1 (L1);
receiving a connection setup message only in L1, the connection setup message comprising parameters for at least one of radio bearer configuration, master cell group configuration, cell selection configuration, cell reselection configuration, or measurement configuration; and
transmitting a setup complete message only in the L1.

2. The method of claim 1 wherein receiving the connection setup message comprises:
receiving a first stage downlink control information (DCI) on a physical downlink control channel that schedules a first resource in a physical downlink shared channel;
receiving a second stage DCI in the first resource that schedules a second resource in the physical downlink shared channel; and
receiving L1 data for connection setup in the second resource.

3. The method of claim 1 further comprising:
transmitting a physical random access channel (PRACH) transmission on a random access channel (RACH) resource associated with L1 setup; and
receiving with a random access response; and
wherein transmitting the setup request only in L1 uses resources scheduled in the random access response.

4. The method of claim 3 wherein:
a first set of RACH resources is associated with L1 setup, and a second set of RACH resources is associated with radio resource control (RRC) setup; and
the RACH resource associated with L1 setup belongs to the first set of RACH resources associated with L1 setup.

5. The method of claim 4 further comprising:
receiving signaling indicating the first set of RACH resources and the second set of RACH resources.

6. The method of claim 1 further comprising:
receiving L1 data for reconfiguration only in L1, the L1 data for reconfiguration comprising at least one updated parameter.

7. The method of claim 6 wherein receiving the L1 data for reconfiguration only in L1 comprises:
receiving another first stage DCI on a physical downlink control channel that schedules a third resource in a physical downlink shared channel;
receiving another second stage DCI in the third resource that schedules a fourth resource in the physical downlink shared channel, wherein another second stage DCI indicates that the fourth resource contains the L1 data for reconfiguration; and
receiving the L1 data for reconfiguration in the fourth resource in the physical downlink shared channel.

8. A method, comprising:
receiving a setup request from an apparatus only in layer 1 (L1);
transmitting a connection setup message only in L1, the connection setup message comprising parameters for at least one of for radio bearer configuration, master cell group configuration, cell selection configuration, cell reselection configuration, or measurement configuration; and
receiving a setup complete message only in the L1.

9. The method of claim 8 wherein transmitting the connection setup message comprises:
transmitting a first stage DCI on a physical downlink control channel that schedules a first resource in a physical downlink shared channel;
transmitting a second stage DCI in the first resource that schedules a second resource in a physical downlink shared channel; and
transmitting L1 data for connection setup in the second resource.

10. The method of claim 8 further comprising:
receiving a physical random access channel (PRACH) transmission on a random access channel (RACH) resource associated with L1 setup; and
transmitting with a random access response; and
wherein receiving the setup request only in L1 uses resources scheduled in the random access response.

11. The method of claim 10 wherein:
a first set of RACH resources is associated with L1 setup, and a second set of RACH resources is associated with RRC setup; and
the RACH resource associated with L1 setup belongs to the first set of RACH resources associated with L1 setup.

12. The method of claim 8 further comprising:
transmitting L1 data for reconfiguration only in L1, the L1 data for reconfiguration comprising at least one updated parameter.

13. The method of claim 12 wherein transmitting the L1 data for reconfiguration only in L1 comprises:
transmitting another first stage DCI on a physical downlink control channel that schedules a third resource in a physical downlink shared channel;
transmitting another second stage DCI in the third resource that schedules a fourth resource in the physical downlink shared channel, wherein another second stage DCI indicates that the fourth resource contains the L1 data for reconfiguration; and
transmitting the L1 data for reconfiguration in the fourth resource.

14. An apparatus comprising at least one processor coupled with a non-transitory computer-readable medium storing instructions, wherein when the instructions are executed by the at least one processor, the apparatus is caused to perform operations comprising:
transmitting a setup request only in layer 1 (L1);
receiving a connection setup message only in L1, the connection setup message comprising parameters for at least one of radio bearer configuration, master cell group configuration, cell selection configuration, cell reselection configuration, or measurement configuration; and
transmitting a setup complete message only in the L1.

15. The apparatus of claim 14 wherein receiving the connection setup message comprises:
receiving a first stage downlink control information (DCI) on a physical downlink control channel that schedules a first resource in a physical downlink shared channel;
receiving a second stage DCI in the first resource that schedules a second resource in a physical downlink shared channel; and
receiving L1 data for connection setup in the second resource.

16. The apparatus of claim 14 further comprising:
transmitting a physical random access channel (PRACH) transmission on a random access channel (RACH) resource associated with L1 setup; and
receiving with a random access response; and
wherein transmitting the setup request only in L1 uses resources scheduled in the random access response.

17. The apparatus of claim 16 wherein:
a first set of random access channel (RACH) resources is associated with L1 setup, and a second set of RACH resources is associated with radio resource control (RRC) setup; and
the RACH resource associated with L1 setup belongs to the first set of RACH resources associated with L1 setup.

18. The apparatus of claim 17 further comprising receiving signaling indicating the first set of RACH resources and the second set of RACH resources.

19. The apparatus of claim 14 further comprising:
receiving L1 data for reconfiguration only in L1, the L1 data for reconfiguration comprising at least one updated parameter.

20. The apparatus of claim 19 wherein receiving the L1 data for reconfiguration only in L1 comprises:
receiving another first stage DCI on a physical downlink control channel that schedules a third resource in a physical downlink shared channel;
receiving another second stage DCI in the third resource that schedules a fourth resource in the physical downlink shared channel, wherein another second stage DCI indicates that the fourth resource contains the L1 data for reconfiguration; and
receiving the L1 data for reconfiguration in the fourth resource in the physical downlink shared channel.
